(19) United States
(12) Patent Application Publication
(10) Pub. No.: US 2010/0144318 A1
(43) Pub. Date: Jun. 10, 2010

(54) AUTOMATIC USER PROFILE EXCHANGE DEVICE AND METHOD

(75) Inventor: David Scott Cable, Sigtuna (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/331,472

(22) Filed: Dec. 10, 2008

(51) Int. Cl. H04M 3/493; H04L 12/58; H04W 4/12

(52) U.S. Cl. 455/412.1; 455/414.2; 455/466

(57) ABSTRACT

A device and method of exchanging user profile information by sending and receiving background communications with another device. The background communications include a command to send a background communication embedded with an updated user profile to the requesting device. The embedded user profile is received by the requesting device and synchronized with a profile list to automatically update the user profile on the requesting device.

### TECHNICAL FIELD OF THE INVENTION

The technology of the present disclosure relates generally to portable electronic devices and, more particularly, to an automatic user profile exchange device and method for exchanging a user profile.

### BACKGROUND

Mobile wireless electronic devices are becoming increasingly popular. For example, mobile telephones, portable computers, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and hands free headset interfaces. Mobile devices typically communicate with other mobile devices over mobile or cellular telephone communication networks.

Mobile devices often include an address book to store information related to a user's contacts. Often, the information in the address book must be manually entered and updated for each contact. For example, if a user wants to associate an image with a particular contact, the user must manually associate the image with the contact.

Social networking sites (e.g., MySpace, LinkedIn, and Facebook) allow users to create and customize a user profile that may be shared with other users. Each user of the website may customize a user profile that other users of the website can view. The user profiles typically are stored on a common server so that different users of the site can search for and view the different user profiles. A user of the site can customize a contact list that includes the user profiles of selected users. By accessing information stored on the common server, the contact list always contains updated information for each user in the list.

Social networking sites generally require user registration or membership. Thus, if a person has not registered on a particular site, his or her profile would not be available. Also, given the relatively large number of social networking sites available, it is unlikely that any one social networking site would include every contact that a user would like to add to a contact list.

Social networking websites may be accessed on mobile phones that have internet access. If the internet is not available, however, it can be difficult or impossible for the user to view updated information for the contacts in the contact list.

Improvements in the exchange of user profiles are generally desirable.

### SUMMARY

In order to enhance the updating of user profiles on mobile devices, the present disclosure describes a device and methods of automatically exchanging and/or updating user profiles with background communications sent between the devices. The background communications may be sent over commonly available data bearers, such as, for example, multimedia message service (“MMS”), short message service (“SMS”), or internet protocol (IP) multimedia services (“IMS”), and the like.

The automatic profile exchange may occur at regular intervals, for example, once per day, or may by initiated every time a user calls or sends a message to another device. By updating the user profiles stored in a profile list on the device in this manner, the user profiles for each contact in the list are kept current with little or no user interaction or manual entry of data by the user.

According to one aspect of the disclosure, a method of exchanging a user profile includes automatically sending a background communication from a first mobile device to a second mobile device, wherein the background communication includes a request for a user profile stored on the second mobile device, receiving a background communication from the second mobile device that includes the requested user profile, and synchronizing the user profile received from the second mobile device with a profile list on the first mobile device.

According to another aspect of the method, the method further includes initiating a communication with the second mobile device or receiving a communication from the second mobile device, and the automatically sending the background communication to the second mobile device occurs in response to initiating or receiving the communication.

According to another aspect of the method, the initiating or receiving comprises initiating or receiving one of a phone call, text message, a video message, or an email.

According to another aspect the automatically sending a background communication includes sending a background SMS message, a background MMS message, or a background IMS message to the second mobile device.

According to another aspect, of the method, the profile list includes a plurality of different user profiles, and the synchronizing includes updating the user profile in the profile list if the received user profile is for a known contact or adding a new user profile to the profile list is the received user profile is for an unknown contact.

According to another aspect, the method further includes executing a program stored on a machine readable medium which, when executed by a machine, provides for the steps of automatically sending the background communication to the second mobile device, receiving the background communication from the second mobile device, and synchronizing the user profile received form the second mobile device with the profile list on the first mobile device.

According to another aspect of the disclosure, a method of exchanging a user profile includes receiving a first background communication with a first mobile device, wherein the background communication includes a request to send a user profile to a second mobile device, embedding the user profile into a second background communication, and sending the second background communication to the second mobile device.

According to another aspect of the method, the embedding comprises embedding the user profile in a background SMS message, a background MMS message or a background IMS message.

According to another aspect of the method, the embedding further includes selecting a user profile from at least one user profile stored on the first mobile device.

According to another aspect of the method, at least one user profile includes a limited user profile and a full user profile, and the selecting includes selecting the limited profile if the first background communication is received from a known contact or selecting the full user profile if the first background communication is received from an unknown contact.

According to another aspect of the method, the first background communication further includes commanding the first mobile device to download a profile sharing application if the first mobile device does not include the profile sharing application.

According to another aspect of the method, the first background communication further includes commanding the first mobile device to download the profile sharing application from the second mobile device or from a remote server if the first mobile device does not include the profile sharing application.

According to another aspect, the method further includes prompting the user of the first mobile device to authorize the embedding and sending of the user profile to the second mobile device.

According to another aspect, the method further includes executing a program stored on a machine readable medium which, when executed by a machine, provides for the steps of receiving the first background communication with a first mobile device, embedding the user profile into the second background communication, and sending the second background communication to the second mobile device.

According to another aspect of the disclosure, a mobile device includes a profile list and a profile exchange section, wherein the profile list is accessible by the profile exchange section and the profile exchange section includes: (i) a sending section operable to automatically send a first background communication to a another mobile device wherein the background communication that includes a command to send a user profile to the mobile device; (ii) a receiving section operable to receive a message in response to the background communication, wherein the message includes an embedded user profile; and (iii) a synchronizing section operable to synchronize the embedded user profile with the profile list.

According to another aspect, the device further includes at least one user profile for a user of the mobile device, the receiving section is operable to receive a background communication from another mobile device, the profile exchange section includes an embedding section operable to embed a user profile from the at least one user profile of the user of the mobile device into a background communication, and the sending section is operable to send the background communication with the embedded user profile to the second mobile device.

According to another aspect of the device, at least one user profile for the user of the mobile device includes a full user profile and a limited user profile, and the background communication includes either the full user profile or the limited user profile based upon whether the background communication is from a known contact or from an unknown contact.

According to another aspect of the device, the profile sharing application includes a prompt to allow a user to authorize the profile exchange section to embed and to send the at least one user profile in response to a received command.

According to another aspect of the device, a communication with a second mobile device automatically initiates the profile exchange section, the communication including one of a telephone call, email, or text message.

According to another aspect of the device, the background communication includes a background SMS message, a background MMS message, or a background IMS message.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic illustration of two mobile devices exchanging user profiles in accordance with aspects of the invention;

FIG. 2 is a flow chart representing an exemplary method of requesting and receiving a user profile in accordance with aspects of the invention;

FIG. 3 is a flow chart representing an exemplary method of sending a user profile in accordance with aspects of the invention;

FIG. 4 is a schematic view of an exemplary portable communication device;

FIG. 5 is a schematic block diagram of an exemplary portable communication device in accordance with aspects of the invention;

FIG. 6A-6C is a flow chart representing an exemplary method of exchanging user profiles in accordance with aspects of the invention.

### DETAILED DESCRIPTION OF EMBODIMENTS

Embodiments are described with reference to the drawings, wherein like reference numerals are used to refer to like elements throughout. It will be understood that the figures are not necessarily to scale.

While embodiments are described primarily in the context of a portable radio communications device, such as the illustrated mobile telephone, it will be appreciated that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a communicator, an electronic organizer, a personal digital assistant (PDA), a smart phone, a portable communication apparatus, etc.

The term “electronic equipment” includes portable radio communication equipment. The term “portable radio communication equipment,” which herein after is referred to as a “mobile device,” a “mobile phone,” or a “mobile radio terminal,” includes all equipment such as mobile telephones, pagers, communicators, i.e., electronic organizers, personal digital assistants (PDAs), smart phones, portable communication apparatus, portable communication device or the like.

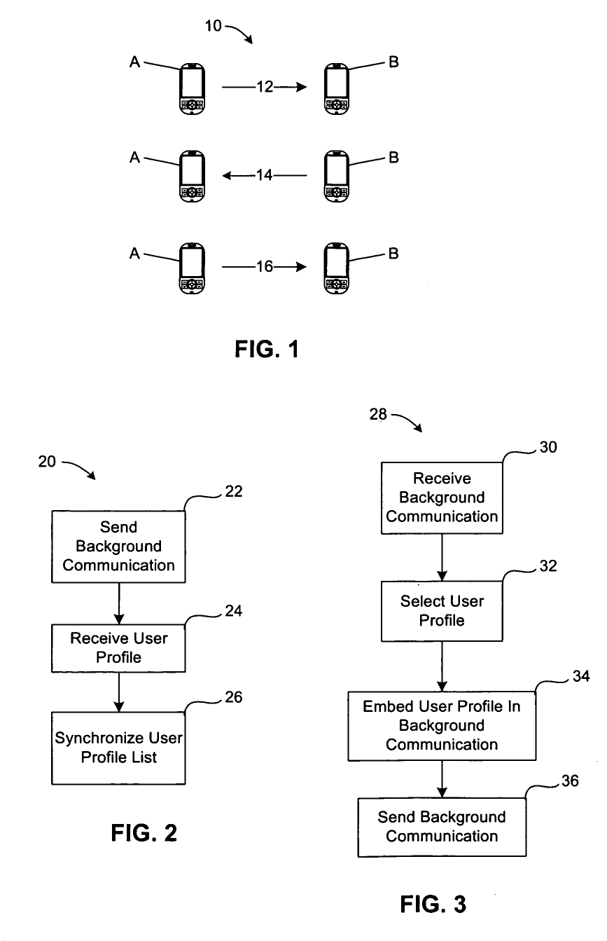

Referring initially to FIG. 1, an exemplary illustration of a profile exchange 10 between a first mobile device A and a second mobile device B is shown. Device A includes one or more user profiles for the user of device A. Likewise, device B includes one or more user profiles for the user of device B. For example, one user profile for the user of device A may include a full user profile to share with known contacts and another user profile for the user of device A may include be a limited user profile that includes less information, and which may be shared with unknown contacts. The user profiles may include data or information such as a recent picture or image of the user and contact information, such as the user's address and phone number, business contact information, etc. The user profiles may, for example, be a virtual card (vCard), cardDAV file or other file that includes user profile information.

The first mobile device A and the second mobile device B communicate with one another via a communications network to engage in voice communications, text, video or picture messaging, etc. The devices A, B also communicate with one another via background communications, which include the exchange of data, commands, messages and/or other content by operations that run in the background of the mobile device. Such background communications may occur automatically or with little user prompting, and may occur without the knowledge of the user. Background communications may be sent by commonly available data carriers, such as, for example, Short Message Service (“SMS”), Multimedia Messaging Service (“MMS”), IP Multimedia Service (“IMS”), and the like.

As indicated generally at 12 in FIG. 1, device A initiates a profile exchange by sending a background communication to device B. The background communication includes a command or request for device B to send a user profile to device A.

Upon receipt of the background communication, device B retrieves an appropriate user profile for sharing with device A. For example, if the user of device A is known by the user of device B, then device B may select the user's full user profile to send to device A. If the user of device A is unknown to the user of device B, however, device B may select a limited user profile to send to device A.

Device B embeds the selected user profile into a background communication that is sent to device A, as indicated generally at 14 in FIG. 1. Device A receives the background communication with the embedded user profile and synchronizes the user profile with a profile list stored on device A. If the profile list on device A already includes a user profile for the user of device B, the received user profile will be parsed such that only the updated information in the user profile is synchronized with the information in the profile list. If user A's profile list does not include a user profile for user B, a new entry is created and the user profile is added to user A's profile list. After synchronization, the profile list on device A includes the most current user profile for the user of device B.

In addition to the user profile, the background communication received from device B may include a request or command for device A to send a user profile for the user of device A to device B. As described above with respect to device B, device A selects an appropriate user profile to send to device B. The selected user profile is then embedded into a background communication that is sent to device B, as shown generally at 16 in FIG. 1. Device B receives the background communication with the embedded user profile and synchronizes the user profile with a profile list stored on device B. After synchronization, the profile list on device B includes the most current user profile for the user of device A.

The exchange of background communications may occur automatically and without user prompting. For example, the profile exchange through background communications may occur at regular intervals, e.g., hourly, daily, weekly, monthly, etc. Thus, at a regular interval, device A may send a background communication to every mobile device stored in the profile list on device A requesting an updated user profile. Each device on the contact list may respond to device A with a background communication that includes an embedded user profile. Device A synchronizes the embedded user profiles with the user profiles stored in the profile list. Additionally, as described above, the background communication from each responding device also may include a request for a user profile from device A, and device A may respond with an updated user profile that is sent to the device in a background communication or message. The profile lists on both devices A, B, therefore, can be updated regularly to contain the most current user profile of each user in the user profile list.

The exchange of background communications also may be initiated when the devices engage in communications with each other. For example, after establishing a telephone call, device A may automatically send a background communication to device B with a request for a user profile. In another example, the sending or receiving a message, such as a text message, video message, instant message, etc., may initiate the profile exchange.

Referring to FIG. 2, an exemplary method 20 of requesting and receiving a user profile is shown in more detail. Using the example of FIG. 1, the method 20 will be described with respect to device A above. The profile exchange is initiated by device A at functional block 22 when a background communication such as a background MMS/SMS/IMS message is sent from device A to device B.

The background communication may be sent automatically after a telephone call is established between the devices or at a regularly scheduled interval. The user of device A also may prompt the device A to send the background communication to another device, or the user may manually send a background communication to device B with a request for an updated user profile.

At functional block 24, device A receives a background communication or message from the device to which the user profile request was sent, e.g., device B in the example of FIG. 1. The background communication includes an updated user profile for the user of device B.

At functional block 26, the user profile received from device B is added to or synchronized with the profile list stored on the mobile device A. Device A may synchronize the received user profile using any number of different techniques. For example, during synchronization, device A may search the profile list stored in the memory of device A to determine if the user profile has been previously added to the profile list on device A. Device A may compare different fields from the received user profile to the corresponding fields in the profile list. Device A may compare the date that the each field was last updated by the user of device B to the date that the user of device A last updated the user profile, and only the information that has been recently changed will be updated. By updating each individual field based upon the last date that the field was modified, the device A may avoid updating fields that may have been manually modified by the user of device A to avoid losing or overwriting customized content for a particular user.

In another example, the background communication sent at functional block 22 also may include the last date that the user profile for the user of device B was updated. Likewise, the user profile on device A may include the date that the user of the device A last updated the user profile. The two dates can be compared with one another, and if the dates are different, it can be assumed that the initiating device A does not have the most recent version of the user profile from device B stored in the profile list on device A. The user profile from device B can then be synchronized with the profile list on device A.

If the user profile is a vCard, the profile list may be synchronized by using a vCard parser. Other known methods of updating and/or synchronizing user profiles will be appreciated by one of skill in the art.

Referring to FIG. 3, a method 28 of sending a user profile is shown in more detail. Using the example of FIG. 1, the method 28 is described with respect to device B above. The method begins at functional block 30 when device B receives a background communication that includes a request or a command for device B to send a user profile to another device, e.g., device A.

In response to the background communication, device B selects a user profile to send to device A, as shown in block 32. As described above, device B may include multiple different user profiles, and each user profile stored on device B may include different information. For example, the device may include a business user profile, which may include a professional photograph of the user and the user's business contact information. The device B also may include a social user profile with a funny or casual photograph and the user's home address and phone number. Another user profile may be a limited user profile that includes only the first name of the user and the user's phone number, but no other information.

The user also may customize the user profiles such that certain user profiles are sent based upon the identity of the requesting device. For example, the profile list on device B may include a group of business contacts, and the user can customize a business profile such that when a request is received from a business contact, the business profile is sent. Similarly, contacts can be added to certain groups based upon different social networks or groups of friends and a specific user profile can be sent when a request is received from a member of that group.

The device B also may select a user profile at functional block 32 based upon whether the background communication is received from a known or from an unknown person. For example, the device may send the limited profile if the request is received from a device that is unknown to the user, but may send a full profile if the request is received from a contact that is already included in the user's profile list.

Alternatively, device B may ignore the request, for example, if device B is not equipped with profile exchange functionality or if the user profile exchange functionality has been disabled. The user of device B also may override the profile exchange functionality to ignore requests from certain individuals or groups of contacts, for example, by creating a blacklist of contacts that the user does not wish to share a user profile with. The device B also may prompt the user when a profile request is received and the user can then select which profile that the user would like to send in response to the request.

After the user profile is selected at functional block 32, the method proceeds to function block 34. At functional block 34, device B embeds the selected user profile into a background communication. As described above, the background communication may be a background MMS/SMS/IMS message, for example. As will be appreciated, the user profile may be embedded directly into the background communication or may be sent to the requesting device A as an attachment to a message, which may be automatically downloaded by the receiving device A.

At functional block 36, the background communication is sent to the requesting device A. It will be appreciated that receiving of the background communication 30, selecting of a user profile 32, embedding of the user profile into a background communication 34, and sending of the background communication to the requesting device A occur automatically in response to the receipt of a request from device A. Thus, the sharing of the user profile may occur without any user prompting.

As will be appreciated, device A also includes the functionality required to complete the method 28 described in FIG. 3, e.g., receiving a background communication with a user profile request 30, selecting a user profile to send to the requesting device 32, embedding the user profile in a background communication 34, and sending the background communication with the user profile to the requesting device 36. Likewise, device B includes the functionality required to complete the method 20 described in FIG. 2, including sending a background communication for a user profile 22, receiving a background communication with an embedded user profile 23, and synchronizing the received user profile with information stored in a profile list 26.

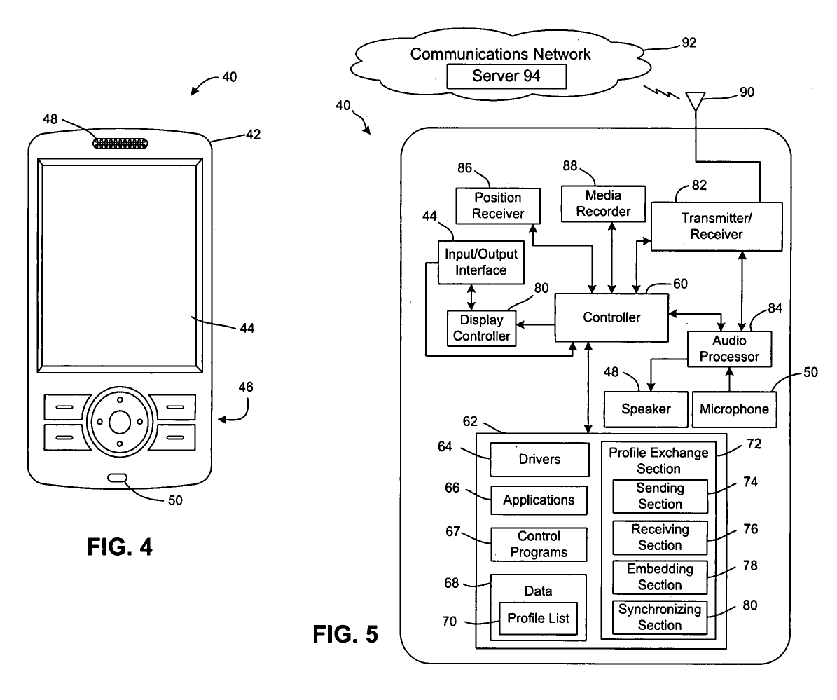

Referring now to FIG. 4, a portable communication device 40 is shown in accordance with aspects of the present invention. In the exemplary embodiment described herein, the portable communication device is a mobile phone 40 (also referred to as a “mobile device”). Of course, it will be appreciated that while described primarily in the context of a mobile phone, the invention is not intended to be limited to a mobile phone, the description here is applicable to other portable communication devices and other types of electronic equipment. The mobile phone 40 is shown as having a “block” type of housing 42, but it will be appreciated that other housing types, such as clamshell or slide-type housings may be utilized without departing from the scope of the present invention.

The mobile phone 40 illustrated in FIG. 1 is a touch-sensitive input device having a touch-sensitive display 44 (also referred to as a display, a touch screen, a touch-input device or a touch-input display). The touch-sensitive display 44 may be any conventional design that outputs information indicative of the location of a user input when the user input is in contact with the surface of the touch-sensitive display 44. The phone 40 may have one or more functional keys 46, e.g., a joystick or rocker key, a speaker 48 and a microphone 50. While not explicitly shown, the mobile phone also may include an alphanumeric keypad separate from any keypad embodied in the touch-sensitive display 44. The functional keys 46 (as well as any alphanumeric keypad provided by way of the touch-sensitive display or any conventional keypad) facilitate controlling operation of the mobile phone 40 by allowing for entry of alphanumeric information, such as telephone numbers, phone lists, contact information, text messages, email messages, notes and the like. The functional keys 46 typically facilitate navigation through various user menus including initiating and conducting phone calls and other communications.

The touch-sensitive display 44 displays information to a user, such as recorded digital media, e.g., recorded photos and videos, operating state, time, phone numbers, e-mails, text messages, text documents, contact information and various navigational menus, which enable the user to utilize the various features of the mobile phone 40. The touch-sensitive display 44 displays a user desktop (also referred to as a “home screen”), which may include one or more objects, such as icons for initiating one or more of the programs resident on the mobile device and/or for changing the setting of the mobile device.

The circuitry and software of the mobile phone 40 is coupled with input devices, such as the alphanumeric keypad (alone or via the touch-sensitive display), the functional keys 46, and the microphone 50, as well as to the input/output devices, including the touch-sensitive display 44 and the speaker 48. Also, while the exemplary mobile phone 40 is described as having functional keys 46 and a touch-sensitive display 44, it will be appreciated that the mobile phone may include only the touch-sensitive display 44 as the primary means for receiving alphanumeric user input and/or navigation commands, or may have a QWERTY keyboard.

FIG. 5 represents a schematic view of a functional block diagram of the portable communication device 40. The portable communication device 40 includes a controller 60 that controls the overall operation of the device 40. The controller 60 may include any commercially available or custom microprocessor or microcontroller. Memory 62 is operatively connected to the controller 60 for storing drivers 64, applications 66, control programs 67 and data 68 used by the portable communication device 40. The memory 62 is representative of the overall hierarchy of memory devices containing software and data used to implement the functionality of the portable communication device 40 in accordance with one or more aspects described herein. The memory 62 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 40 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), Internet content, and so forth.

It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. It is also noted that the portable communication device 40 may include an IP multimedia subsystem architectural framework for delivering internet protocol (IP) multimedia services, commonly referred to as “IMS.” IMS may be used by devices having data receiving and sending capabilities. Data, including background commands and messages, may be exchanged via the IMS standard by sending and receiving data to the device's IP address.

In the illustrated embodiment the data 68 includes a profile list 70. The profile list 70 may include user profile information for user contacts, including people and/or businesses, etc. The user profiles may include information such as the name, email address, telephone number, mailing address, photographs and the like. In one embodiment, the user profile includes a virtual card (vCard), cardDAV file or other file that includes user profile or user contact information. Furthermore, as described above, the profile list may include one or more groups of contacts, for example, business contacts, social contacts, etc.

The data 68 also may include one or more user profiles for the user of the device 40. The user profiles for the user of the device 40 may include a full user profile, a limited user profile, a business user profile, a social user profile, etc., for example, as described above with respect to FIG. 3. The user profile also may be stored as a virtual card (vCard), cardDAV file or other file that includes user profile or user contact information. The user profile for the user of the device 40 also may be stored in the profile list 70.

By storing the user's profile on the device 40, the user of the device 40 is able to locally change or customize the information that will be sent to a contact as part of a user profile exchange. Likewise, the contacts in the profile list 70 can locally update their user profiles, which are stored locally on their respective mobile devices. Every time the user profiles are exchanged, the profile list 70 of the device 40 is updated with the version of the contact's user profile that is stored on the contact's device.

After the profiles are exchanged, the profile list 70 includes the most current version of each contact's user profile, which was prepared by the contact, rather than the user of the requesting device. Thus, there is little need for the user of the requesting device to manually enter or associate information with the user profiles in the profile list 70. Furthermore, any changes to the contact's user profile, for example, updates to the contact's address, phone number, picture, etc., can be made by the contact on the contact's device, and the next time that the user and the contact exchange user profiles, the updated profile from the contact will be automatically synchronized with the data stored in requesting device's profile list 70.

The profile list 70 may be used with the different applications 66 stored in the memory 62 of the portable communication device 40. For example, an instant messaging application may access the profile list 70 to display a screen name and photograph of the person with whom a chat is being conducted. In another example, the picture and/or phone number of a user may be displayed on the display 44 when a call or message is received from a person that has a contact stored in the contact list 70.

The memory 62 also includes a profile exchange section 72, which includes a sending section 74 for automatically sending background communications to other devices, a receiving section 76 for receiving background communications from other devices, an embedding section 76 for embedding a selected user profile into a background communication, and a synchronizing section 78 for synchronizing or adding user profiles received in a background communication to the profile list 70. Although shown as being part of the profile exchange section 72, it will be appreciated that some or all of the functionality of the sending section 72, the receiving section 74, the embedding section 76 and the synchronizing section 78, may overlap with other functions of the mobile device, and thus may be included or incorporated into other sections of the mobile device 40.

The applications 66 and profile exchange section 72 as well as other functionality of the portable communication device 40 may be embodied as executable program code that is resident in and executed by the portable communication device 40. The executable program code may be stored on a computer or machine-readable storage medium, such as ROM, RAM, EEPROM, etc., and executed by a processor (e.g., controller 60). The program may be a stand-alone software application or form a part of a software application that carries out additional tasks related to the portable communication device 40. It will be apparent to a person having ordinary skill in the art of computer programming, and specifically in application programming for portable communication devices, mobile telephones or other electronic devices, how to program a portable communication device to operate and carry out logical functions associated with the applications 66 and the profile exchange section 72. Accordingly, details as to specific programming code have been left out for the sake of brevity. Also, while the code may be executed by the controller 60 in accordance with an exemplary embodiment, such controller functionality could also be carried out via dedicated hardware, firmware, software, or combinations thereof, without departing from the scope of the invention.

The portable communication device 40 also includes I/O device drivers, which include software routines that are accessed through the controller 60 (or by an operating system (not shown) stored in memory 62). The input/output interface or touch-sensitive display 44 is operatively coupled to and controlled by a display controller 80 (e.g., a suitable microcontroller or microprocessor) and configured to facilitate user input to the device 40. The I/O interface 44 also is operatively coupled to the controller 60.

The applications 66 and the profile exchange section 72 comprise functionality, programs, circuitry, commands, or algorithms, etc., that implement various features of the portable communication device 40, such as voice calls, e-mail, Internet access, text entry and editing, word processing, multimedia messaging, contact manager and the like. As is described more fully below, the profile exchange section 72 comprise a program(s), logic routine(s), code or circuitry to automatically exchange user profile information with other electronic devices.

With continued reference to FIG. 5, the controller 60 interfaces with the aforementioned I/O interface 44 (and any other user interface device(s)), a transmitter/receiver 82 (often referred to as a transceiver), and audio processing circuitry, such as an audio processor 84. The audio processor 84 also processes the audio signals transmitted by and received from the transmitter/receiver 82. Coupled to the audio processor 84 are the speaker 48 and microphone 50, which enable a user to listen and speak via the portable communication device 40. Audio data may be passed to the audio processor 84 for playback to the user. The audio data may include, for example, audio data from an audio file stored in the memory 62 and retrieved by the controller 60. The audio processor 84 may include any appropriate buffers, decoders, amplifiers and the like.

The portable communication device 40 also may include a position determination element or position receiver 86, such as a global positioning system (GPS) receiver, and a media recorder 88 (e.g., a still camera, a video camera, an audio recorder or the like) that captures digital pictures, audio and/or video. Image, audio and/or video files corresponding to the pictures, songs and/or video may be stored in memory 62.

An antenna 90 is coupled to the transmitter/receiver 82 such that the transmitter/receiver 82 transmits and receives signals via antenna 90 to a communications network 92, as is conventional. The communications network 92 may include a server 94 (or servers) for managing calls placed by and destined to the electronic device 40, transmitting data to and receiving data from the electronic device 40, including text messages, and carrying out any other support functions.

The server 92 communicates with the electronic device 40 via a transmission medium. The transmission medium may be any appropriate device or assembly, including, for example, a communications base station (e.g., a cellular service tower, or “cell” tower), a wireless access point, a satellite, etc. The network 92 may support the communications activity of multiple electronic devices and other types of end user devices. As will be appreciated, the server 94 may be configured as a typical computer system used to carry out server functions and may include a processor configured to execute software containing logical instructions that embody the functions of the server 94 and a memory to store such software and any related databases. In alternative arrangements, the electronic device 40 may wirelessly communicate directly with another electronic device (e.g., another mobile telephone or a computer) and without an intervening network.

The portable communication device 40 also may include one or more local wireless interfaces, such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 40 to the adapter, another mobile radio terminal, a computer, or any other electronic device. Also, the wireless interface may be an interface suitable for communication within a cellular network or other wireless wide-area network (WWAN).

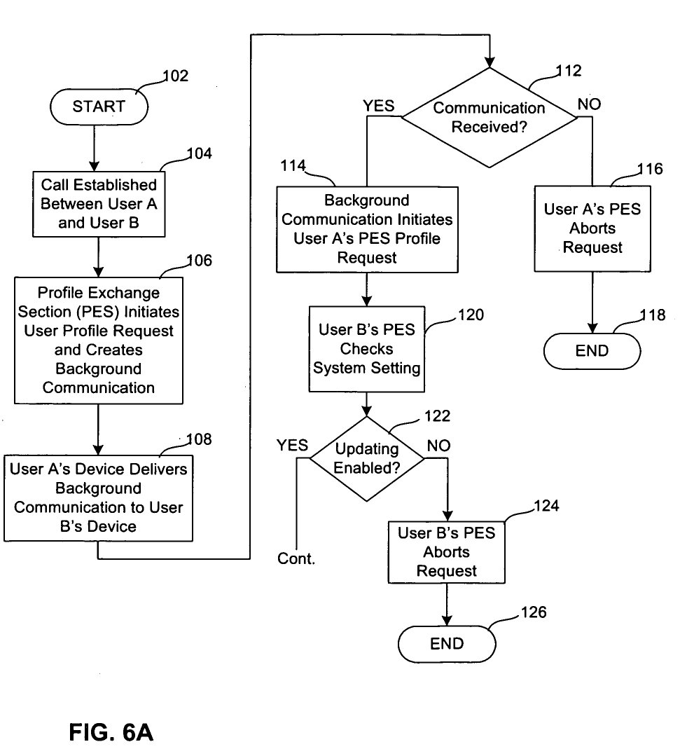

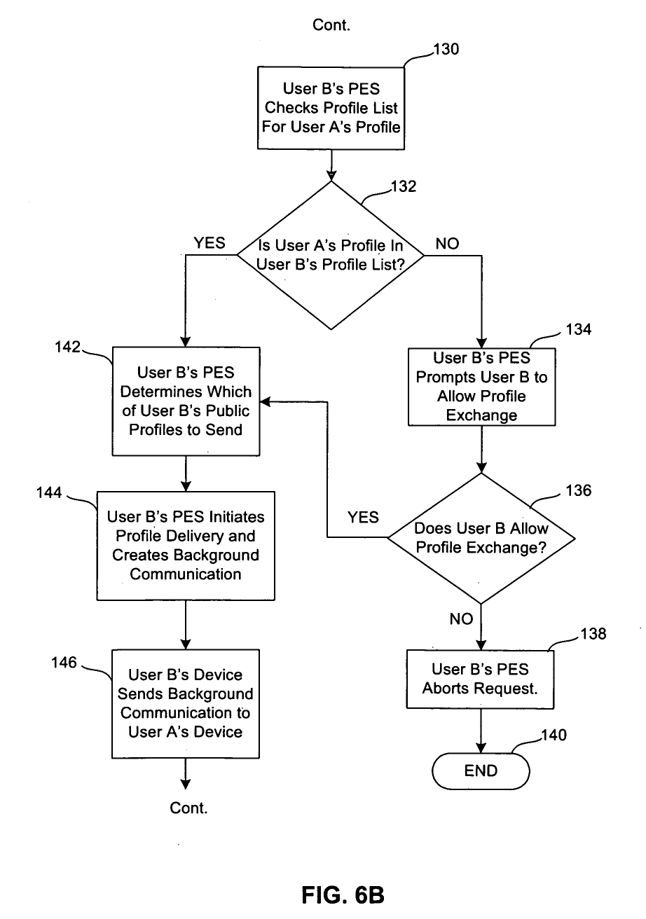

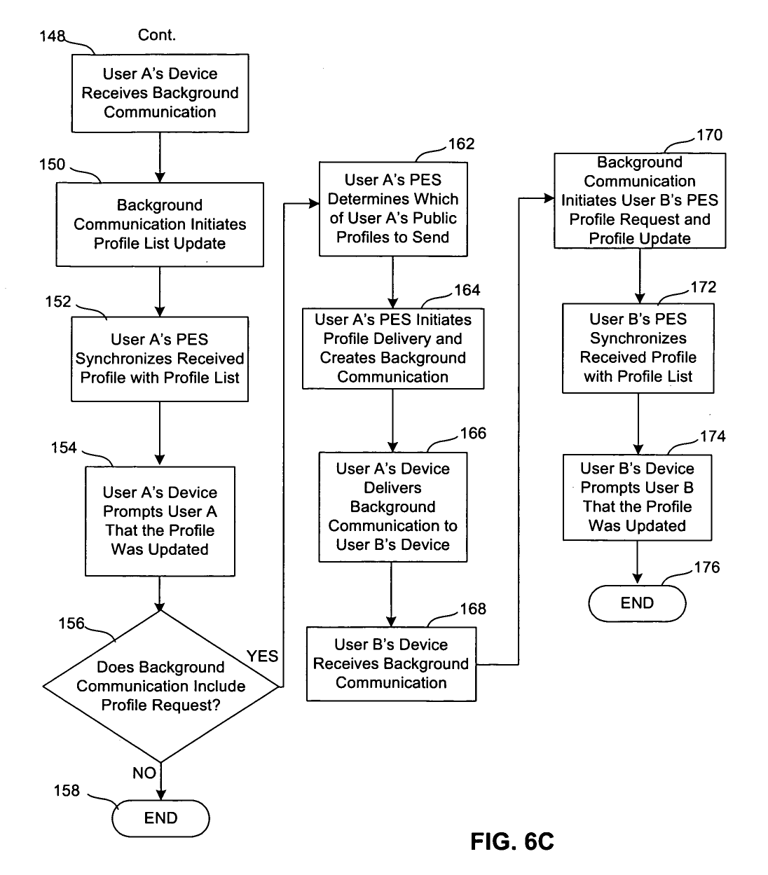

With additional reference to FIGS. 6A-6C, illustrated are logical operations to implement an exemplary method of automatically exchanging user profiles with the portable communication device 40. The exemplary method may be carried out by executing an embodiment of the user profile exchange section 72, for example as shown in FIG. 5. Thus, the flow chart of FIGS. 6A-6C may be thought of as depicting steps of a method carried out by the electronic device 40. Although FIGS. 6A-6C show a specific order of executing functional logic blocks, the order of executing the blocks may be changed relative to the order shown. Also, two or more blocks shown in succession may be executed concurrently or with partial concurrence and certain blocks also may be omitted.

In the method described below with respect to FIGS. 6A-6C, it is assumed that a first user (user A) and a second user (user B) are each operating respective mobile devices with user profile exchange functionality. For ease of description, the respective sections of mobile device A are denoted with an “a” and the respective sections of mobile device B are denoted with an a “b”. For example, user A is operating mobile device A, which includes a profile list 70a, a profile exchange section 72a, a sending section 74a, a receiving section 76a, an embedding section 78a, and a synchronizing section 80a, while user B is operating mobile device B, which includes a profile list 70b, a profile exchange section 72b, a sending section 74b, a receiving section 76b, an embedding section 78b, and a synchronizing section 80b.

The method 100 of automatically exchanging user profiles starts at block 102. At block 104, user A starts the exchange of user profiles by initiating a call to user B. A call is established between user A and user B when user B answers user A's call. After the call is established, the profile exchange section 72a (also referred to as “PES” in FIGS. 6A-6C) of device A automatically initiates a user profile request at block 106.

The profile request is initiated by creating background communication to send to device B. As described above, the background communication can be a background MMS/SMS/IMS message that includes a command or a request for user B's profile. At block 108, the sending section 74a of device A sends the background communication to device B.

Continuing to block 112, device A determines if the background communication was received by device B. If the background communication is received by the receiving section 76b of device B, the method proceeds to block 114 in which the background communication initiates user A's user profile request. If the background communication is not received, the method continues to block 116 in which device A aborts the request for user B's profile and the profile exchange section 72a ends the request at block 118.

Device A can determine if the background communication has been received in a number of different ways. For example, device A may determine whether the background communication has been received by device B by waiting a period of time for device B to respond to device A's request. If device A does not receive a response from device B within a predetermined amount of time, it can be assumed that device B will not respond to the request with a user profile. For example, if device A does not receive a response to the background communication within several seconds, then device A will abort the request at block 116 and the profile exchange will end at block 118.

Device B may not respond to device A's request for several reasons, including, for example, if the profile exchange section 72b is disabled or if device B is not loaded with a profile exchange section 72b. Another reason that device B may not respond to device A's request may be because user A is unknown to user B, and user B has configured the profile exchange section 72b to deny a request for a user profile that is received from an unknown user. The profile exchange section 72b of device B also may send a message to device A indicating that the request for user B's profile has been denied, at which point device A will abort the request at block 116 and the profile exchange will end at block 118.

If the background command is received by device B, the method proceeds to block 114. At block 114, device B initiates user A's profile request. At block 120, the profile exchange section 72b of device B checks the system settings of device B to determine if user profile updating is enabled or disabled. If user profile updating is disabled on device B, the method proceeds to block 124, where user B's device aborts user A's profile request and the method ends at block 126. If user profile updating is enabled, the method continues at block 130 in FIG. 6B.

At block 130, user B's profile exchange section 72b checks the user profiles stored in the user B's profile list 70b. As described above, user B may customize the profile exchange section 72b according to user B's preferences. For example, to protect user B's privacy, user B may customize the settings of the profile exchange section 72b to only send user B's profile to contacts that are in user B's profile list 70b. User B also may customize the system to never send a user profile to an unknown user device or to always deny a request for a user profile if the request is received from a particular contact (e.g., if the contact is on a blacklist).

Thus, if user A is not a contact in user B's profile list, the method proceeds to block 134. At block 134, user B is prompted or alerted to indicate that a request has been received from an unknown contact. At block 136, user B can determine whether or not to share user B's profile with the unknown contact. If user B decides not to share a user profile with user A, the method proceeds to block 138, where user B's profile exchange section 72b aborts the profile request and the method ends at block 140. Alternatively, if user B would like to share the user profile with user A, the method proceeds to block 142.

Referring back to block 132, if user A's profile is in user B's profile list 70b then it may be safe to assume that user B would like to share user B's profile with user A and the method proceeds to block 142 where user B's device determines which user profile to send to user A.

As described above, user B may have a plurality of different user profiles. The user profile that is selected to send to user A may be determined based upon the identity of user A. For example, if user A is a business contact, a business profile may be selected, but if user A is a new friend, a full user profile may be selected. Alternatively, user B may customize the settings to only send a limited user profile if the request is received from a contact that is not in the profile list 70b.

After determining which user profile to send, device B initiates delivery of the user profile at block 144. Device B automatically creates a background communication and embeds the selected user profile into the background communication with the embedding section 78b. At block 146, the background communication is sent automatically to user A by the sending section 74b of device B.

The method continues in FIG. 5C at block 148. At block 148, user A's receiving section 76a receives the background communication sent from device B. The background communication initiates a user profile update at block 150. At block 152, the embedded user profile is extracted and synchronized with the information in user A's profile list 70a by the synchronizing section 80a. It will be appreciated that if user A's profile list 70a does not include user B's profile, a new entry for user B may be added to the profile list 70a at block 152. Optionally at block 154, user A may be prompted that user B's profile has been added or updated.

At block 156, it is determined whether the background communication received from device B includes a request or command for device A to send user A's profile to device B. If the background communication from user B does not include such a command, then the method ends at block 160. If the background communication includes a command for user A's user profile, the method proceeds to block 162.

At block 162, user A's profile exchange section 72a determines which of user A's profiles to send to user B. As described above, this determination may be based on the identity of user B or whether user B is a known or unknown to user A.

After determining which user profile to send, device A initiates delivery of the user profile at block 164. Device A creates a background communication and embeds the selected user profile into the background communication with the embedding section 78a. At block 166, the background communication is sent to user B by the sending section 74a of device A.

The background communication is received by the receiving section 76b of device B at block 168. The background communication initiates user B's profile exchange section 72b at block 170 to initiate the synchronization of user A's user profile with user B's profile list 70b. User A's profile is synchronized with user B's profile list 70b at block 172. It will be appreciated that if user B's profile list 70b does not previously include user A's profile, a new entry for user A may be added to the profile list 70b at block 172. Optionally at block 174, user B may be prompted that user A's profile has been added or updated. The method ends at block 176.

The profile exchange between the devices may continue until both user profiles have been exchanged, even if the call or other communication between the devices has ended. For example, if the call is very short, or if the call is accidentally terminated, the devices may continue communicating with one another through the exchange of background communication until both user profiles have been updated.

Furthermore, it will be appreciated that the exchange of user profiles may occur simultaneously, e.g., user A's device and user B's device may simultaneously send respective profile requests when a communication occurs between the devices. It also will be appreciated that while described as a telephone call, the communication may be a text message, video message, picture message, chat message or another communication between the devices. Furthermore, as described above, the profile exchange may occur automatically on at a regular interval by querying each profile in the profile list 70 to determine if any of the user profiles have been updated.

In some instances, the device that receives the initial background communication to share the user profile may not have a profile exchange section or software stored or installed on the device. In such circumstances the requesting device, e.g., user A's device in the above example, may direct the other device to a location where the profile exchange program or software can be automatically downloaded and added to the device. For example the device may be directed to a server from which the profile exchange section can be downloaded. Alternatively, the requesting device may transfer the profile exchange section software directly to the device, and the profile exchange section software may be automatically installed.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

Although certain embodiments have been shown and described, it is understood that equivalents and modifications falling within the scope of the appended claims will occur to others who are skilled in the art upon the reading and understanding of this specification.

What is claimed is:

1. A method of exchanging a user profile comprising:
automatically sending a background communication from a first mobile device to a second mobile device, wherein the background communication includes a request for a user profile stored on the second mobile device;
receiving a background communication from the second mobile device that includes the requested user profile; and
synchronizing the user profile received from the second mobile device with a profile list on the first mobile device.

2. The method of claim 1, further comprising initiating a communication with the second mobile device or receiving a communication from the second mobile device;
wherein the automatically sending the background communication to the second mobile device occurs in response to initiating or receiving the communication.

3. The method of claim 2, wherein the initiating or receiving comprises initiating or receiving one of a phone call, text message, a video message, or an email.

4. The method of claim 1, wherein the automatically sending a background communication includes sending a background SMS message, a background MMS message, or a background IMS message to the second mobile device.

5. The method of claim 1, wherein the profile list includes a plurality of different user profiles, and
wherein the synchronizing comprises updating the user profile in the profile list if the received user profile is for a known contact or adding a new user profile to the profile list is the received user profile is for an unknown contact.

6. The method of claim 1, further comprising executing a program stored on a machine readable medium which, when executed by a machine, provides for the steps of automatically sending the background communication to the second mobile device, receiving the background communication from the second mobile device, and synchronizing the user profile received form the second mobile device with the profile list on the first mobile device.

7. A method of exchanging a user profile comprising:
receiving a first background communication with a first mobile device, wherein the background communication includes a request to send a user profile to a second mobile device;
embedding the user profile into a second background communication;
sending the second background communication to the second mobile device.

8. The method of claim 7, wherein the embedding comprises embedding the user profile in a background SMS message, a background MMS message or a background IMS message.

9. The method of claim 7, the embedding further comprises selecting a user profile from at least one user profile stored on the first mobile device.

10. The method of claim 9, wherein the at least one user profile includes a limited user profile and a full user profile, and the selecting comprises selecting the limited profile if the first background communication is received from a known contact or selecting the full user profile if the first background communication is received from an unknown contact.

11. The method of claim 7, wherein the first background communication further includes commanding the first mobile device to download a profile sharing application if the first mobile device does not include the profile sharing application.

12. The method of claim 7, wherein the first background communication further includes commanding the first mobile device to download the profile sharing application from the second mobile device or from a remote server if the first mobile device does not include the profile sharing application.

13. The method of claim 7, further comprising prompting the user of the first mobile device to authorize the embedding and sending of the user profile to the second mobile device.

14. The method of claim 7, further comprising executing a program stored on a machine readable medium which, when executed by a machine, provides for the steps of receiving the first background communication with a first mobile device, embedding the user profile into the second background communication, and sending the second background communication to the second mobile device.

15. A mobile device comprising:
a profile list; and
a profile exchange section, wherein the profile list is accessible by the profile exchange section and the profile exchange section includes:
(i) a sending section operable to automatically send a first background communication to a another mobile device wherein the background communication that includes a command to send a user profile to the mobile device;
(ii) a receiving section operable to receive a message in response to the background communication, wherein the message includes an embedded user profile; and
(iii) a synchronizing section operable to synchronize the embedded user profile with the profile list.

16. The mobile device of claim 15, further comprising at least one user profile for a user of the mobile device;
wherein the receiving section is operable to receive a background communication from another mobile device;
the profile exchange section includes an embedding section operable to embed a user profile from the at least one user profile of the user of the mobile device into a background communication; and
the sending section is operable to send the background communication with the embedded user profile to the second mobile device.

17. The mobile device of claim 16, wherein the at least one user profile for the user of the mobile device includes a full user profile and a limited user profile; and
wherein the background communication includes either the full user profile or the limited user profile based upon whether the background communication is from a known contact or from an unknown contact.

18. The mobile device of claim 17, wherein the profile sharing application includes a prompt to allow a user to authorize the profile exchange section to embed and to send the at least one user profile in response to a received command.

19. The mobile device of claim 15, wherein a communication with a second mobile device automatically initiates the profile exchange section, the communication including one of a telephone call, email, or text message.

20. The mobile device of claim 15, wherein the background communication includes a background SMS message, a background MMS message, or a background IMS message.
